(19) United States
(12) Patent Application Publication
(10) Pub. No.: US 2020/0338547 A1
(43) Pub. Date: Oct. 29, 2020

(54) AUTOMATED EXTRACTION SYSTEM

(71) Applicant: Custom Sensors & Technology, Fenton, MO (US)

(72) Inventors: Richard Nordman, St. Charles, MO (US); Mike Ponstingl, Sunset Hills, MO (US)

(21) Appl. No.: 16/871,895

(22) Filed: May 11, 2020

Related U.S. Application Data
(63) Continuation-in-part of application No. 15/974,450, filed on May 8, 2018.
(60) Provisional application No. 62/845,950, filed on May 10, 2019.
(60) Provisional application No. 62/599,645, filed on Dec. 15, 2017.
(60) Provisional application No. 62/511,694, filed on May 26, 2017.
(60) Provisional application No. 62/503,144, filed on May 8, 2017.

(51) Int. Cl. B01L 3/00; G01N 21/64; G01N 21/31

(52) U.S. Cl. CPC B01L 3/502; G01N 21/64; B01L 2400/06; B01L 3/567; B01L 2400/0475; G01N 21/31

(57) ABSTRACT

An automated system which can perform automated sample extraction from a process stream, automated analysis on the sample, and then provide output on the results to process control equipment so that parameters of the processing could be altered in response to the testing.

### CROSS-REFERENCE TO RELATED APPLICATIONS

This application claims the benefit of U.S. Provisional Patent Application No. 62/845,950, filed May 10, 2019. This application is also a Continuation-In-Part (CIP) of U.S. patent application Ser. No. 15/974,450 filed May 8, 2018 which claims the benefit of U.S. Provisional Application Ser. No. 62/599,645, filed Dec. 15, 2017; 62/511,694, filed May 26, 2017; and 62/503,144, filed May 8, 2017. The entire disclosure of all the above references is herein incorporated by reference.

### BACKGROUND OF THE INVENTION

### Field of the Invention

The invention relates to systems for automatically extracting a liquid sample, generally from a process stream, and providing for material testing, and specifically photometric testing, thereon.

### Description of the Related Art

There are a number of places where production or activity creates what is effectively a process stream. Continuous manufacturing techniques as well as processes which are continuously acting on elements create a near constant output of end product. An example of this is water purification where an essentially continuous stream of wastewater is taken in and an essentially continuous output of clean water is generated. Similarly, in manufacturing processes such as continuous distillation, it is necessary to essentially have a continuous feed of material fed to a distillation column to provide an essentially continuous feed of end product. This is used, for example in refining crude oil. It should be recognized that virtually any continuous (as opposed to batch) manufacturing process is designed to take in a stream of material and produce a stream of material so long as the process is operating. Still further, processes such as pollution control which operate on flue gas produced from combustion typically also must operate on continuous streams.

In these continuous processes, it should be recognized that monitoring of the process is important. Not all the wastewater or crude oil fed to the system has identical properties and depending on the nature of the input, the process may need to be slightly altered. Further, it is also generally necessary to monitor the output to make sure that the resultant clean water or petroleum distillate is within desired parameters and suitable as an output. Should the end product not meet expectations, or changes in the input be detected, the processes can be altered (for example, temperatures can be lowered or residence times in various phases can be increased) to provide for slightly different manufacturing parameters to make sure that the desired output is obtained.

While the underlying process may be continuous, this monitoring often cannot be continuous. While certain forms of monitors can provide near continuous measurement (for example certain forms of in situ optical sensors) these are not suitable for all forms of monitoring. In some forms, it is necessary to take a sample and perform (often destructive) tests on the sample to determine the composition. If these types of test were performed continuously, there would be no output as the output would be consumed by the testing.

In these types of situations, testing is generally performed on a regular schedule with a small sample being removed from the stream and tested. Traditionally, sample removal and testing has been performed by hand. Specifically, a technician would go and obtain the sample, return it to the lab, perform the testing, and then determine the results. The problem with this system is that while it can verify that inputs or outputs are within target parameters, it generally does not allow for any correction as by the time the testing has been completed, the flow being tested has already moved on. Thus, the testing was effective to verify that everything was working (essentially that the system was abiding by regulations or targets), but not useful to fix problems if it was not.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, it would be desirable to have an automated system which can perform automated sample extraction from a process stream, automated analysis on the sample, and then provide output on the results to process control equipment so that parameters of the processing could be altered in response to the testing.

There is described herein, among other things, a device for handling a sample comprising: a pump; a chamber spaced from said pump and having an attached probe; and a valve arrangement; wherein, said pump will provide a liquid sample from a sample source to said chamber, said liquid sample passing through said valve arrangement; wherein, while said sample is moving through said valve arrangement, a liquid additive is simultaneously pulled from an additive source through said valve arrangement and said liquid sample and said liquid additive are mixed; and wherein a measurement can be taken of said liquid sample and liquid additive mixture in said chamber.

In an embodiment of the device, the liquid sample is an emulsion.

In an embodiment of the device, the measurement is performed on said liquid sample while said sample is an emulsion.

In an embodiment of the device, the liquid additive is a solvent separating a first immiscible from said emulsion.

In an embodiment of the device, the measurement is performed on said first immiscible.

In an embodiment of the device, the measurement is performed on what remains of said emulsion after said first immiscible has been separated.

In an embodiment of the device, the emulsion is an oil and water emulsion.

In an embodiment of the device, the additive is toluene.

In an embodiment of the device, the measurement is a fluorescence measurement.

In an embodiment of the device, the measurement is a light absorption measurement.

### BRIEF DESCRIPTION OF THE DRAWINGS

FIG. 1 shows an embodiment of an Automated Extraction System (AES).

FIG. 2 shows an embodiment of the major components of the AES sample handling portion of the AES of FIG. 1.

FIG. 3 provides a detail view of the stream selecting valve of the AES of FIG. 1.

FIG. 4 indicates the components of the variable displacement syringe pump of the AES of FIG. 1.

FIG. 5 shows alternating fluids between the syringe pump and mixing/analysis chamber to provide the mixing action.

FIG. 6 provides a detail view of the mixing/analysis chamber of FIG. 1.

FIG. 7 provides an embodiment of a photometric transmitter.

FIG. 8 provides a functional diagram of the operation of the photometric transmitter of FIG. 7.

FIG. 9A provides a front view of the AES of FIG. 1 showing air/gas inlets.

FIG. 9B provides a side view of the AES of FIG. 1 showing plumbing connections.

FIG. 10 section gives an overview of the electrical specifications and organization of the photometric transmitter of FIG. 7.

FIG. 11 provides a chart showing an embodiment of buttons on a display in the AES and their various functions.

FIG. 12 shows a general overview of navigation based on the buttons of FIG. 11.

FIG. 13 shows an example of a home screen running on an AES. The home screen includes the buttons of FIG. 11 fluorescence information for a sample.

FIG. 14 shows an example of a security screen which requires authentication of a user before the functions of FIG. 11 may be accessed from the home screen of FIG. 13 as contemplated by FIG. 12.

FIG. 15 shows a setup screen to prepare for calibration of the photometric transmitter.

FIG. 16 shows a calibration in progress.

FIG. 17 shows a screen for manually altering automatic settings of the photometric transmitter.

FIG. 18 provides a flowchart for manual calibration of the photometric transmitter.

FIG. 19 provides a screen for altering the settings of the AES itself.

FIG. 20 provides a screen to allow a user to manually actuate components of the AES.

FIG. 21 provides a screen to set the extraction settings of the AES.

FIG. 22 provides a screen for calibrating the 4-20 mA current loop for transmitting information from the photometric sensor.

FIG. 23 is similar to FIG. 16, but illustrates manual adjustment of a calibration point of the photometric sensor.

FIG. 24 provides a screen for resetting of the password or other access control information.

FIG. 25 Provides for an example of AES Control Panel software for use on an external computer running in Normal Mode.

FIG. 26 provides for an example of the software of FIG. 25 running in Administrative Mode.

FIG. 27 shows a user typing in calibration sample concentrations during an Auto-Tune procedure selected from FIG. 26.

FIG. 28 provides another example of an AES Control Panel software operating in Normal Mode.

FIG. 29 provides an example of an AES Settings tab which is commonly the default administrative mode tab and allows for manual adjustment of volume and time variables in operation of the AES.

FIG. 30 provides an example of a tuner tab which allows for manual selection of the settings used in the auto-tune procedure of FIG. 27.

FIG. 31 provides the ability to review the raw output of the photometric sensor.

FIG. 32 provides the ability to manually actuate the valves and pumps in the AES system.

FIG. 33 allows the user to change the location that the log file generated by the AES is stored.

FIG. 34 allows the user to view or hide the current run status of the AES.

FIG. 35 allows the user to alter the graphing tools used to display the data.

FIG. 36 allows the user to reorganize the graphs within the window.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein are a variety of automated systems for liquid handling and testing which are commonly referred to as “automated extraction systems” or simply AES. AES are generally configured to perform a fully automated liquid-liquid extraction, and to deliver the extract to an analysis cell either in an original mixed form, or a separated form, generally having been mixed with an additive to assist in the analysis, although that is not required. The AES will then also include traditional measurement or analysis tools attached thereto to perform an analysis on the extract such as, but not limited to, measuring the amount of a dispersant or other material in the mixture. Finally, an AES will generally be able to return the tested sample to the process stream, or dispose of it, and provide the results of the measurements performed to a computer or human for analysis.

Measurement on the extracted sample may be performed by, among other things, using an absorbance or fluorescence measurement to determine the concentration of the extracted solute within the sample. These types of measurements may be performed by any type of testing or measurement instrument known now or later discovered and these instruments will generally be mounted to the AES at fixed points as contemplated later in this discussion. The AES may be used to allow the analysis on the extracted sample to occur prior to separation of components of an emulsion or similar composition, on an emulsion which has been allowed to separate naturally, or on an emulsion to which specific solvents or other additives have been added to induce stronger or faster separation. The latter will generally be the preferred method of operation, however, the AES described herein allow for any and all of such actions to be performed on any sample and can be operated to provide different measurements on a sample in multiple different states based on the test to be performed.

Embodiments of AES described herein will generally perform the mechanical functions of extracting a sample from a process environment and then manipulating that sample for testing. Often the sample will be withdrawn from a continuous flow (such as through a pipeline) but that is not required and in alternative embodiments sample can be taken from more static sources (such as, for example, settling tanks). As such, the AES will generally be mounted near a process line at which measurement will be performed.

The AES generally contains components required to operate the handling system and manipulate the sample and will commonly have mounted thereto a selection of apparatus to perform any absorbance, fluorescence, or other measurement on the sample. The system is designed to be mounted remotely in a non-hazardous location, or to be contained within a purged enclosure or other clean room suitable for the particular installation area.

The automatic extraction systems and methods described herein may be used to extract one or more variable volume(s) of liquid samples from a process stream which will generally have within it an emulsion, often of a petroleum or other oil and water such as can be the case with crude oil or similar materials. The systems and methods may also be used to add to this mixture one or more reagents or indicators. These may be added both as the sample is withdrawn and later as the sample is manipulated depending on embodiment and the testing to be performed. These reagents or indicators may provide a measurable reading of the component(s) of the process stream and/or to help separate or identify the components of the process stream. For example, toluene may be added to an oil and water mixture to help the oil and water separate quickly and cleanly. Additionally, the systems and methods may also be used to dynamically dilute one or more samples with a solvent, extract one or more components from a liquid sample, maintain or recreate a colloidal mixture, react one or more reagents with a sample (such as to form a color or a fluorescing tagged molecule), acid/base titration, filter solids from a liquid sample, and other functions each with the ability to control various parameters in the process. The systems and methods may be used with a fluorescence, reflectance, or absorbance-based photometer, but, in an embodiment, any number of other measuring devices or methods known in the art, may be used. These devices may include, without limitation, an ultraviolet-visible spectroscopy or spectrophotometry (UV-VIS), near-infrared (NIR) optical spectrometer, pH electrode, oxidation/reduction potential electrode, conductivity electrode, or temperature measuring device.

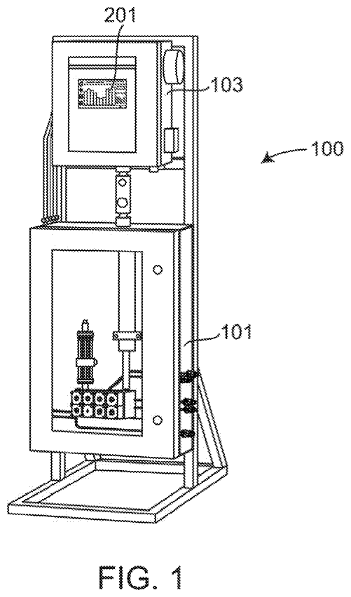

FIG. 1 provides for an Automated Extraction System (AES) (100) suitable for automated sample extraction. The embodiment of FIG. 1 comprises two main components: The sample handling system (101) and the instrument (103). The sample handling system (101) generally contains the items used to perform the mechanical functions of the extraction, and is generally designed to be mounted near to the process line. The instrument (103) is generally designed to be mounted at our near the sample handling system (101) and is where the measurement will be performed. The instrument (103) generally contains all electrical components required to operate the sample handling system (101) and it also performs a fluorescence or other measurement on the sample.

The AES (100) generally automatically performs a liquid-liquid extraction in a process setting. First, the sample handing system (101) retrieves a known volume of sample from a process stream (commonly via a fast loop connection) and may add a known volume of solvent to the sample. It then mixes the sample and solvent phases to create an emulsion, which allows the solute to transfer to the solvent phase (extract). Next, it transports the extract to a generally separate analysis chamber, and the instrument (103) determines the concentration of the solute by means of fluorescence or other measurement depending on the nature of the solute.

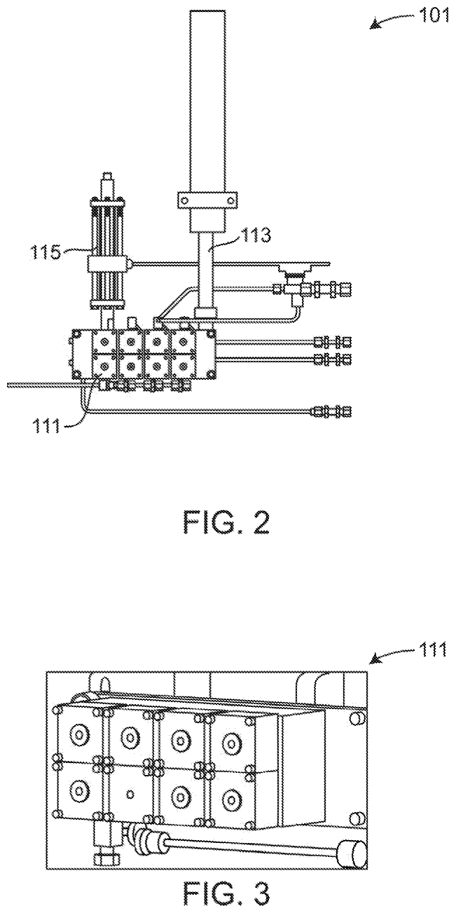

The sample handling system (101) generally comprises 3 major components as indicated in FIG. 2. These are the stream selecting valve (111), the variable displacement syringe pump (113), and the mixing/analysis chamber (115). The stream selecting valve (111) in the depicted embodiment of FIG. 3 is a compact assembly of stream-select modules with built-in pneumatic actuators that can introduce any one of a number of fluids to the syringe pump (113) in a variety of quantities. The number of modules is determined by the number of incoming fluid streams. The AES (100) can be modified to accept additional fluid stream in the forms of solvents, samples, or calibration samples by including additional stream-select modules to the valve assembly. The valve in the embodiment of FIG. 1 is preferably constructed entirely of stainless steel and includes Kalrez seals but this is by no means required.

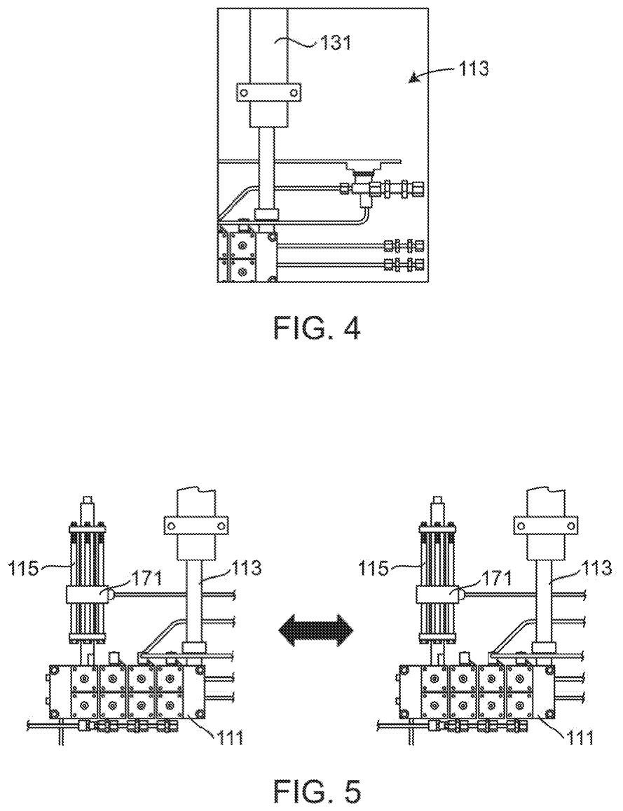

FIG. 4 provides for a more detail view of the variable displacement syringe pump (113) which meters both sample and solvent volumes, and propels all fluids through the system. Sample and solvent ratios may be dynamically calibrated to suit the demands of each unique installation.

The pump (113) includes a pneumatic cylinder (131) which, in the depicted embodiment, is connected to a borosilicate glass tube with an internal piston. The pump volume is approximately 150 mL in the depicted embodiment. Positional control of the syringe (113) may be achieved by the use of two proportional pressure regulators.

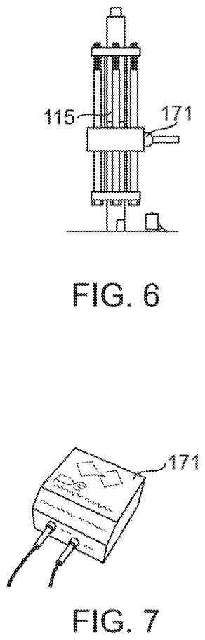

The mixing/analysis chamber (115), which is shown in increased detail in FIG. 6, facilitates the extraction and is located in parallel to the syringe pump (113). The fluids may alternate between the mixing/analysis chamber (113) and syringe pump (115) to provide a mixing action or the mixing action may be performed effectively in the stream switching valve (111) or mixing/analysis chamber (115) by having the action of the syringe pump (115) pulling the joint material into the mixing/analysis chamber (115) and creating shear within the fluid. As indicated in FIG. 5, fluid is passed through the stream switching valve (111), where the locations of valves may be altered as the fluid is flowing so that all desired fluids to be used within the system are incorporated into the process fluid during the extraction process.

Fluid may be exchanged between the mixing/analysis chamber (115) and syringe pump (113) until the extraction process is complete or for mixing. Alternatively, the system (100) may be designed so that no fluid ever enters the syringe pump (115) which simply provides for pressure differentials to move the fluid into or out of the mixing/analysis chamber (115) and stream switching valve (111). The mixing/analysis chamber (115) then includes a measurement probe (171), which in the depicted embodiment is a fluorescence probe which makes a final concentration measurement.

The probe (171) as shown in the embodiment of FIG. 7 comprises a photometric transmitter (171) that uses optical filters to isolate light at certain wavelengths that coincide with target analyte fluorescence. The filters are preferably located within the analyzer, and are specific to the application. Therefore, the probe (171) is generally constructed as a dedicated instrument meant to monitor one or two specific analytes relevant to the process stream. In order to monitor new analytes, the user must generally recalibrate the probe (171) or add additional probes (171) to the instrument (103).

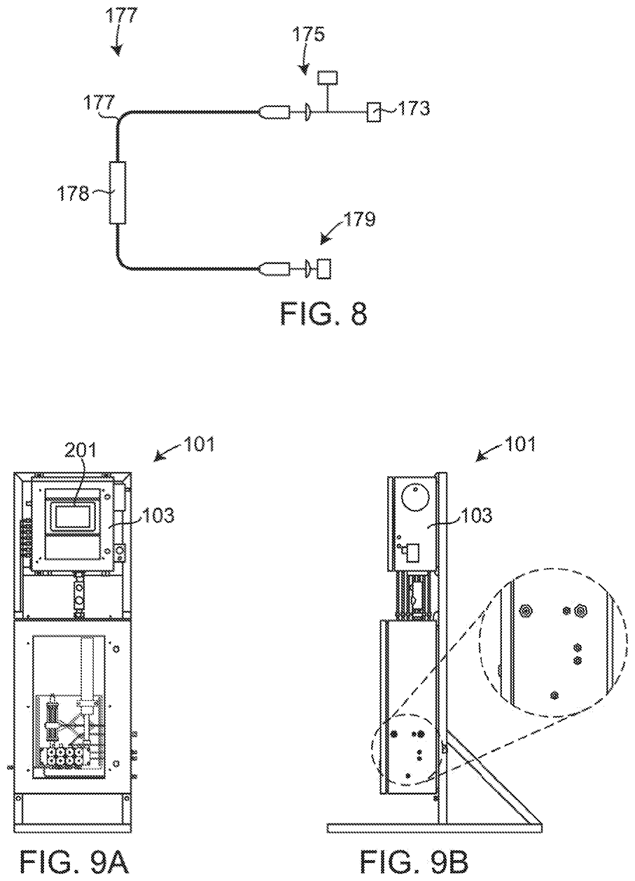

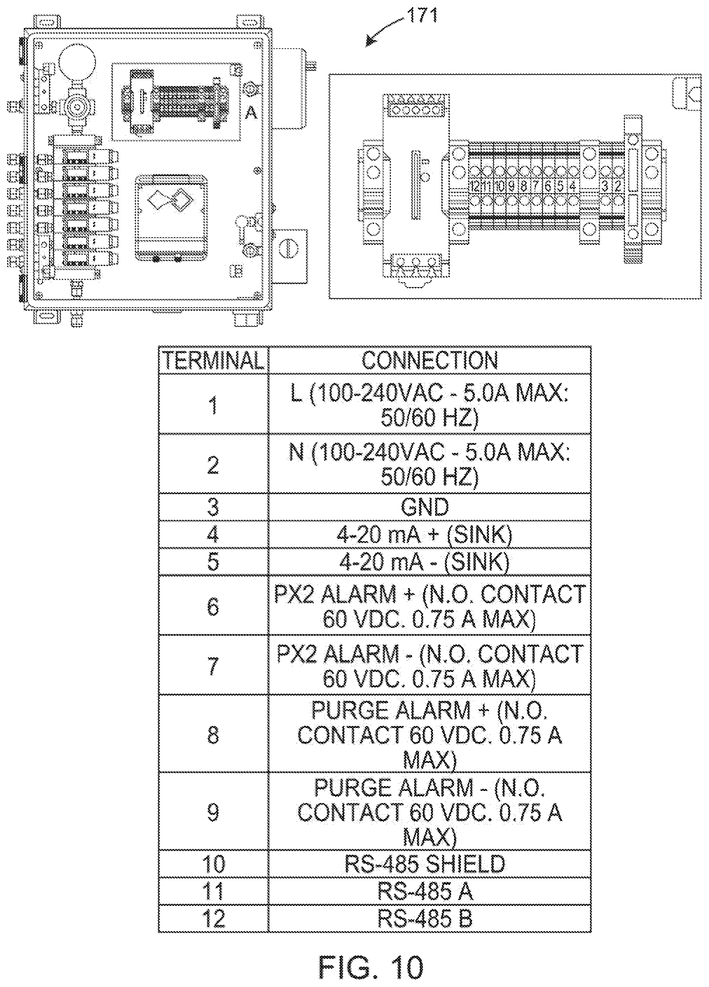

FIG. 8 provides various details of the embodiment of the probe (171). The probe (171) is configured to use a single light source and optical filters to produce a fluorescence measurement. First, the light source (173) emits light that passes through an optical filter (175) that isolates the excitation wavelength into a fiber optic cable (177). The fiber optic cable (177) transfers light at the specified wavelength to the sample interface (178). Then, the light interacts with the process sample where it is emitted at a longer wavelength. Next, the collected light passes through a fiber optic cable (177) to the analyzer (179). When the light reaches the detector in the analyzer (179), and the fluorescence intensity is displayed on the display (201). FIG. 10 provides a general overview of electrical specifications of an embodiment of the probe (171).

The sample handling system (101) and instrument (103) are generally designed to be positioned at or near the process stream to be analyzed and will preferably be relatively small. The embodiment of FIG. 1 is only around 20″W×10″D×50″H and weighs less than 200 lbs. allowing it to be positioned in a large variety of areas. FIGS. 9A and 9B provide an overview of the inlet positions and connections for reference.

In an embodiment, the AES (100) can work as discussed below in conjunction with calibration and measurement of a sample. This description presumes the AES is operating to measure specifics of a crude oil process stream.

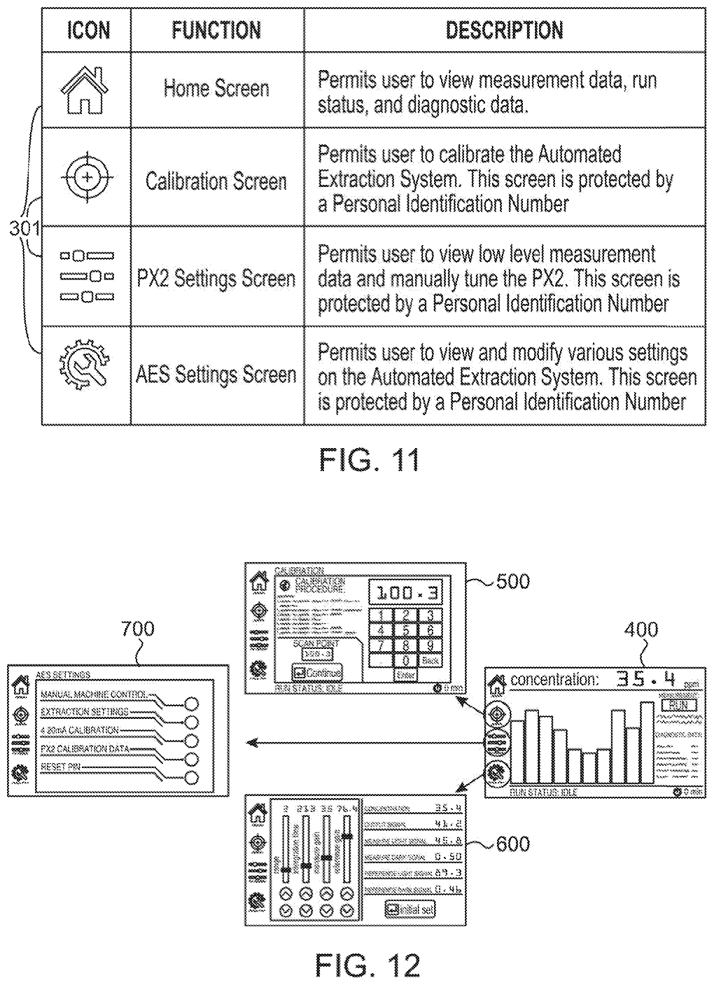

The AES (100) as shown in FIG. 1, includes a display (201) which is preferably a touch screen display. The display (201) allows a user to access operation of the AES (100) related to measurement, calibration, and diagnostic information directly via the AES. FIGS. 11-24 provide for various screens which can be provided on display (201) to provide for control and feedback from the AES (100). As shown in FIGS. 11 and 12, the user interface is generally accessed and controlled via four buttons (301) located on the left side of the display in all displays as can be seen in FIG. 12 and subsequent FIGS. These selections allow navigation through a home screen (which shows current process details) (400), calibration screens (500), probe settings screens (600), and AES settings screens (700).

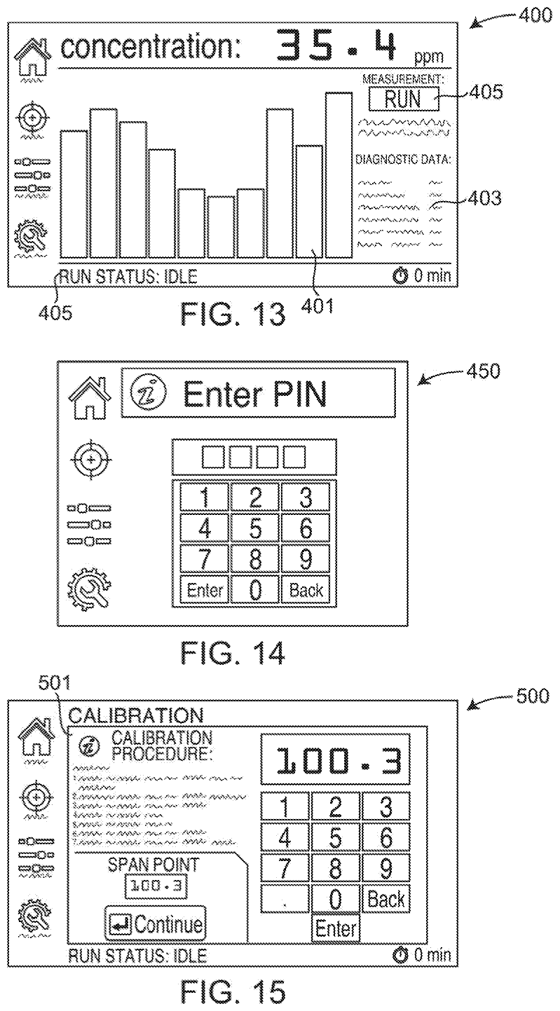

FIG. 13 provides an embodiment of the home screen (400) which is generally the screen which will be displayed when the AES (100) is in use. The home screen (400) generally contains the output signal of the probe as a bar diagram (401), run status (405), and diagnostic data (403). The output signal is the final measurement that is transmitted to the user via the display (201), 4-20 mA, and Modbus outputs. This signal is derived from the ratio of the measure and reference signals.

The measure signal displays the percent of light at the wavelength where the analyte fluoresces. While the reference signal displays the percent of light coming from the light source. The usable range for both measure and reference signals is 0-100%. In the event any of these signals are out of range, an alarm is generally issued and the signal color will change from GREEN to RED on the display to indicate a problem. Such a problem indication may also be transmitted to other systems or to a monitor to allow the process parameters to be changed, if necessary, to respond. The run status (405) component located at the bottom of the screen informs the user of the current operation status of the AES (100). The bar diagram (401) is a visual tool that uses bars to compare data among current and previous measurements. The measurement average value represents the average of ten measurements.

Upon attempting to leave the home screen (400), the user will be taken to a log in screen (450) a shown in FIG. 14. This provides for a security feature so that modification of the operation or calibration of the AES (100) will generally only be performed by an authorized user. After entering the correct password on the log in screen (450), the user will be granted access to the selected screen from the side menu buttons (301) that they previously selected. Once the password has been entered, a user will be generally be granted access to all features of the AES (100) with the password only being required upon attempting to leave the home screen (400) which simplifies security entry.

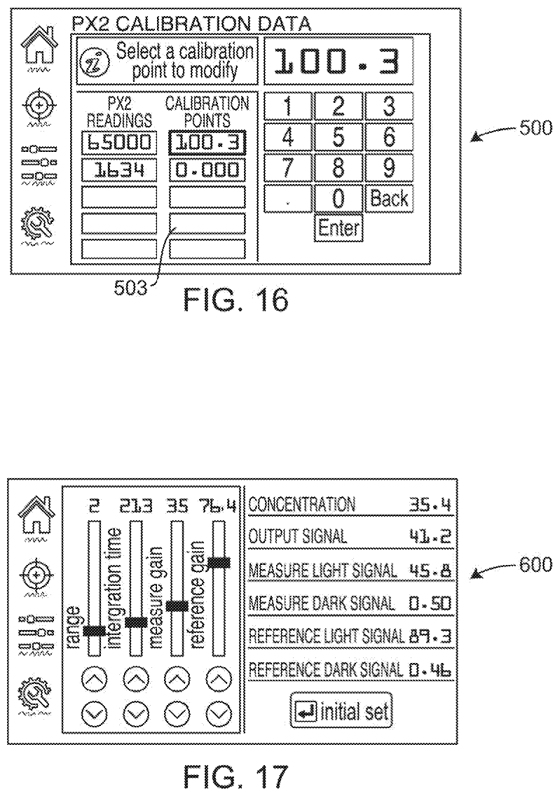

FIGS. 15-16 are directed to calibration (500) of the AES (100) as a whole. Calibration of the AES (100) in conjunction with a crude oil system will typically utilize representative calibration sample comprised of a crude oil sample (with known properties) and the solvent to be used (which will commonly be toluene). For comparison, a sample comprising pure solvent can be automatically generated during the calibration as the solvent is connected to the system.

During the calibration, the user is prompted to enter a calibration sample into the system (501) to perform an analyzer calibration. The AES (100) will automatically determine the appropriate settings for the sample range, and store the calibration points (503). The process will typically proceed as follows.
1. Select the Calibration Screen
2. The user is prompted to insert the calibration sample, close the bypass outlet valve, and open the calibration sample valve.
3. The user is prompted to manually enter the concentration of the calibration sample (numeric values only).
4. The piston pump draws in the calibration sample.
5. The pump delays to allow sample to settle for a length of time set in Extraction Settings.
6. The AES performs Auto-Tune to determine the appropriate settings for the calibration sample.
7. Once the calibration sample measured, a dialogue box will appear indicating that calibration is complete and you will be sent to the Calibration Data Screen for review.

To create the sample it is first generally determined what concentration to calibrate the AES (100) for. This will typically be selected based on expected process characteristics. In this exemplary procedure, there is provided 100 ppm oil in toluene. The procedure general works as follows:
1. Fill the 250 mL volumetric flask to the bottom of the neck with toluene.
   Using the micropipette and tip, add 0.025 ml of oil to the toluene.

$$100 PPM = \frac{0.0 \; 25 ml oil}{250 ml ( Total Volume )} * 1 , 000 \; 000$$

2. Ensure to remove all oil from the micropipette tip with toluene for accurate measurements.
3. Fill with Toluene until the bottom of the meniscus lines up with the fill line on the neck of the volumetric flask.
4. Carefully pour contents into the 250 mL wide-mouth amber nalgene bottle and set aside as your 100 ppm calibration sample.

The probe settings screen (600) of FIG. 17 gives the user full control of the settings that are automatically selected during calibration (500) and also allows the user to view low level signals contained within the instrument. Course control of the settings is achieved by the slider feature, and fine control is permitted via the up/down arrows below the sliders. The settings/signals are described in this chart.

| | | |
|---|---|---|
| Sensor | RANGE | (RANGE: 0-7) Adjusting will affect both the Measure and |
| Settings | | Reference outputs; increase this value to decrease Measure and |
| | | Reference light output |
| | INTEGRATION TIME | (RANGE: 3-1,000 ms) Adjusting will affect both the Measure |
| | | and Reference outputs; increase this value to increase Measure |
| | | and Reference Light output |
| | MEASURE GAIN | (0-100%) Adjusting will affect ONLY the Measure outputs |
| | | (PMT-equipped units); increase this value to increase Measure |
| | | Light output |
| | REFERENCE GAIN | (RANGE: 0-100%) Adjusting will affect ONLY the Reference |
| | | outputs; increase this value to increase Reference Light output |
| | INITIAL SET | Allows the user to normalize the unit without needing to fully |
| | | recalibrate. |
| DIAGNOSTIC | CONCENTRATION | Display of the final, calibrated measurement output of the |
| SIGNALS | | Automated Extraction System |
| | OUTPUT SIGNAL | (RANGE: 0-100%) The Output Signal is the raw fluorescence |
| | | signal from the sample at the wavelength of interest. This |
| | | measurement is derived from the ratio of the measure and |
| | | reference signals below. |
| | ML SIGNAL | (RANGE: 0-100%) The Measure Light Signal is a signal from the |
| | | measure detector when the light source is turned ON. This is the |
| | | primary signal used for determining the optical fluorescence of |
| | | the sample. |
| | MD SIGNAL | (RANGE: 0-100%) The Measure Dark Signal is a signal from the |
| | | measure detector when the light source is turned OFF. This |
| | | signal is used to remove the effects of ambient light and |
| | | electronic noise on the measure detector. |
| | RL SIGNAL | (RANGE: 0-100%) The Reference Light Signal is a signal from |
| | | the reference detector when the light source is turned ON. This |
| | | signal is used to remove the effects of light source drift over long |
| | | periods of time. |
| | RD SIGNAL | (RANGE: 0-100%) The Reference Dark Signal is a signal from |
| | | the reference detector when the light source is turned OFF. This |
| | | signal is used to remove the effects of electronic noise on the |
| | | reference detector. |

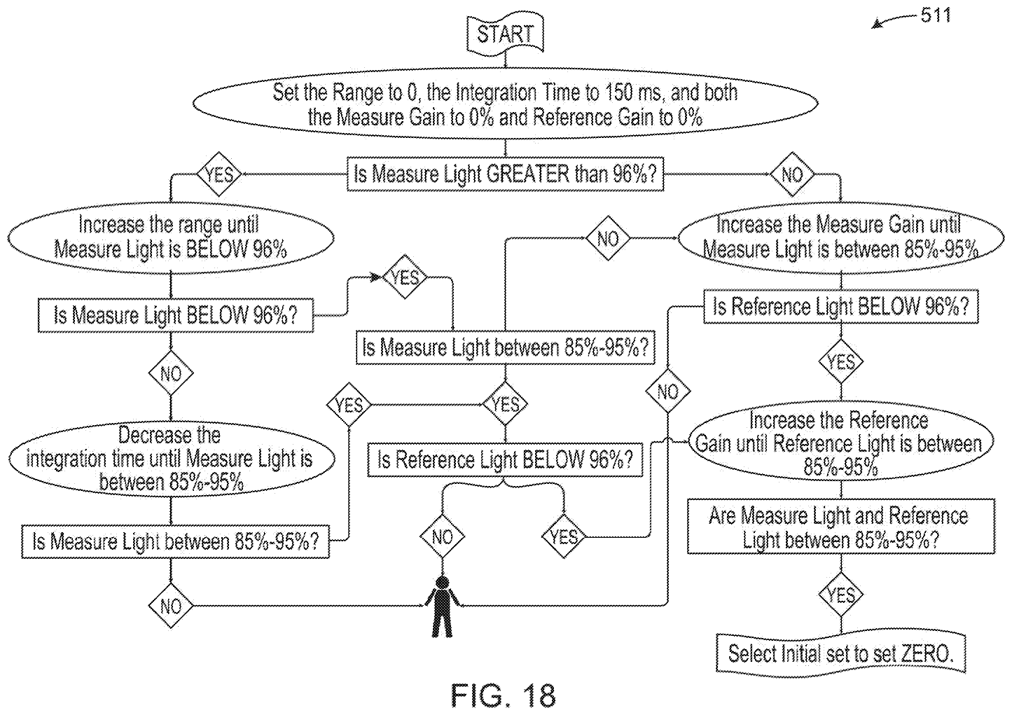

If calibration (500) is not able to select appropriate settings automatically, it might be necessary to manually adjust the probe settings independent of the Calibration Screen (500). Should this happen, it is generally desirable that using the highest concentration sample the user manually adjust the measure light and reference light between 85-95% of full scale. Minimize the measure dark and reference dark signals. This process is generally depicted in FIG. 18 in a flowchart diagram (511).

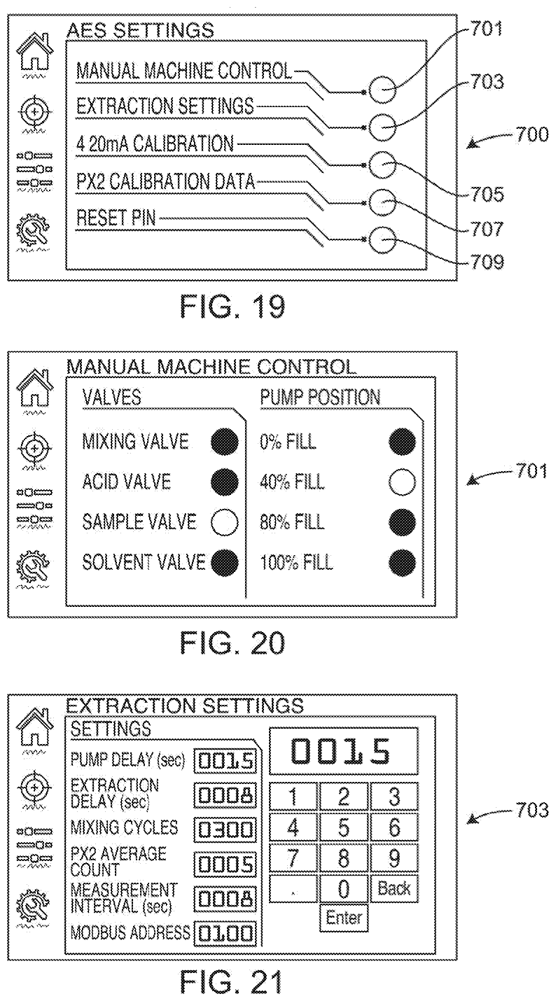

The AES Settings screen (700) of FIG. 19 is the initial screen to accessing allows the user to calibrate the 4-20 mA outputs (705), review and edit calibration data for the sensor (707), edit extraction settings (703), set a new PIN (709), and gives access to manual machine control (701). The Manual Machine Control (701) is depicted in FIG. 20 and allows the user to manually actuate the various valves and pumps in the AES system. This tab also contains all of the volume variables that can be adjusted for a particular application. The Extraction Settings (703) tab is shown in FIG. 21 and contains all of the time variables that can be adjusted for a particular application. The user can manually adjust the pump delay, extraction delay, and mixing cycles. The user can also modify the Modbus Address.

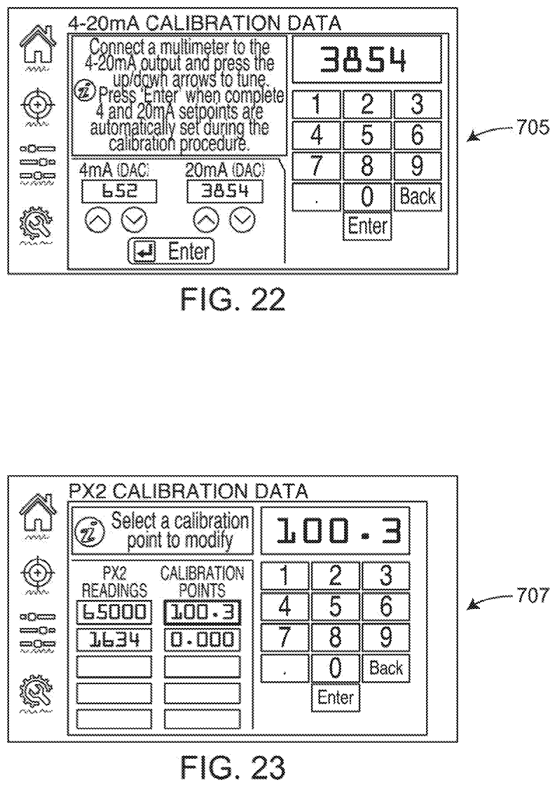

FIG. 22 shows the detail for calibration of the 4-20 mA output (705). The calibration procedure typically utilizes a multi-meter or similar device and may be performed as follows:
1) The “4 to 20 mA Calibration” is selected in the AES Settings.
2) The red (positive) lead of the multimeter is touched to terminal position #4 (4-20 mA +) and the black lead to terminal position #5 (4-20 mA −).
3) The 4 and 20 mA outputs are calibrated by selecting the up and down arrows while checking the output on the multi-meter.

FIG. 23 provides a screen for calibration (707) of the Photometric transmitter. Calibration data points may be adjusted by selecting the desired point and entering a new value.

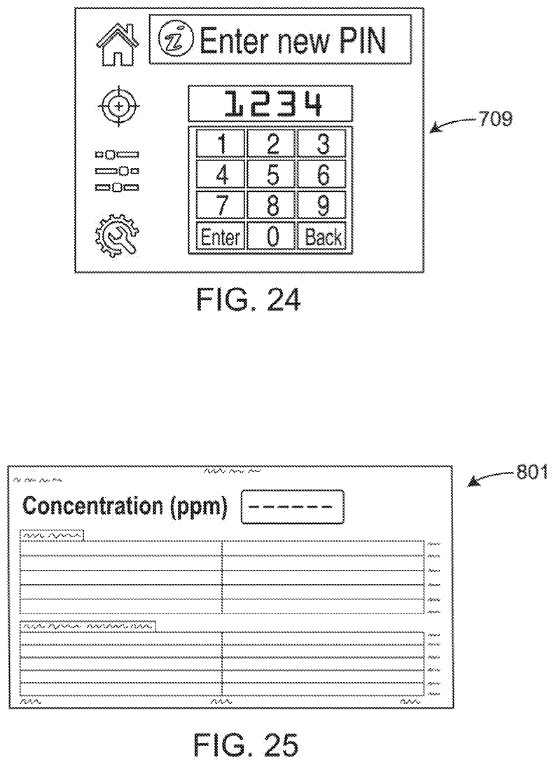

FIG. 24 provides for resetting of the access password (709). As should be apparent, the reset screen is beyond the password entry so changing of the password does require prior knowledge of the current password.

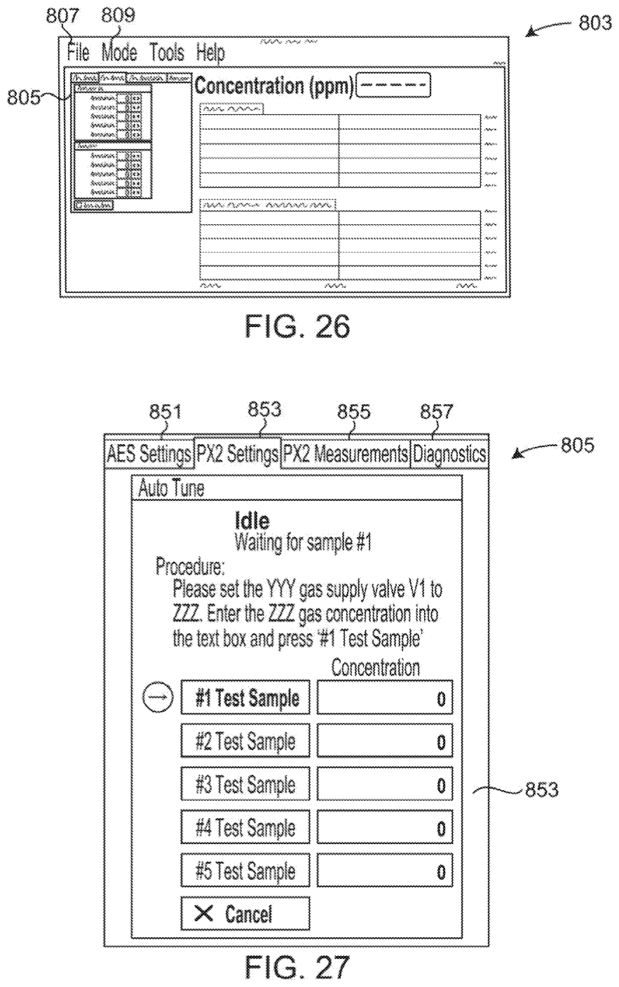

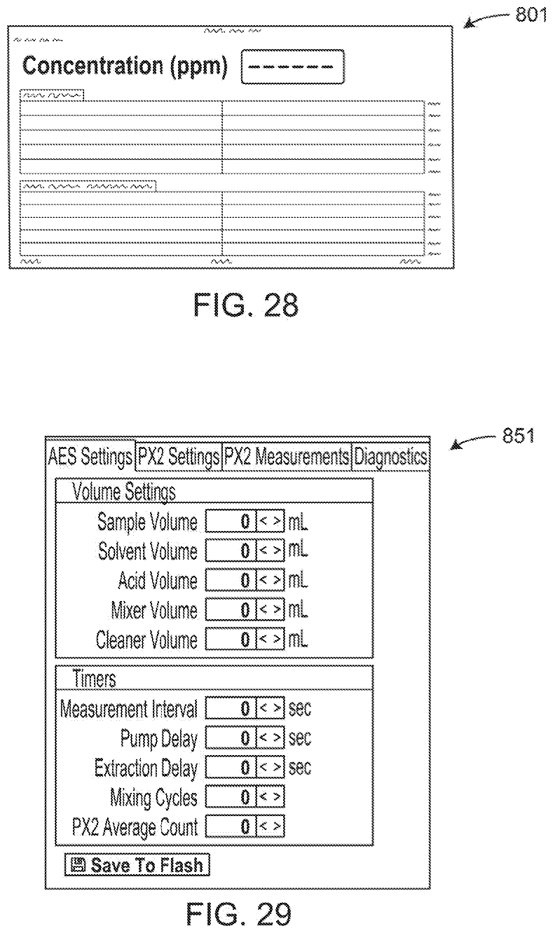

While FIGS. 11-24 provide for the screen operation of the display (171) on the AES (100), the AES (100) may also be controlled remotely utilizing a separate computer or similar device utilizing software on a control panel. FIGS. 25-36 provide for an embodiment of a software control panel for utilizing the AES (100). FIG. 25 shows the “Normal Mode” (801) which is typically entered by default, giving the user access to basic graphing and logging control. To gain full access to all of the features, the user must log into the password-protected “Administrative Mode” (803). These features are otherwise hidden to protect them from being changed by unauthorized users. FIG. 26 depicts the various controls that can be accessed in Administrative Mode (803) as illustrated by the additional window (805) on the left.

The Menu Bar for additional features can be found in the top left corner of the screen (803) and extends to the top right corner of the AES Control Panel App window. It contains a number of dropdown menus where users have access to enable actions such as Sample Measurement, Clean, Backflush, and Auto-Tune while in Normal Mode.

| | | |
|---|---|---|
| MENU | FILE | Open historical data saved as .px2 files |
| BAR | | Save data from current session as a .px2 file (only viewable in app) |
| | | Exit the app |
| | MODE | Idle places the system in an inactive state |
| | | Sample Measurement enables automatic liquid-liquid extractions |
| | | Clean initiates a system cleaning cycle that uses solvent to remove leftover sample |
| | | in the mixing chamber |
| | | Backflush initiates a cleaning cycle that pumps solvent into the sample line that |
| | | connects the AES to the process line. |
| | | Auto-Tune automatically adjusts instrument settings for optimal measurements |
| | TOOLS | Mode: Normal presents the app without access to manual instrument controls |
| | | Mode: Administrative is password-protected and gives access to manual |
| | | instrument controls |
| | | Log File Location allows the user to change where the log file is saved |
| | | Display Run Status visualizes the measurement progress |
| | | Trends: Show Tools displays/hides the graphical tool bar |
| | | Trends: Enable Layout Changes allows the user to reorganize the graphs within |
| | | the AES Control Panel App screen |
| | HELP | Open User Manual as a PDF |
| | | Demo Mode open the app without being connected to the AES Instrument |
| | | About the software, including version number |
| | APP | The currently installed version of the PX2 Control Panel App |
| | VERSION | |

The Modes (807) dropdown will generally have the following options: Idle, Sample Measurement, Clean, Backflush, and PX2 Auto-Tune. During Idle mode, the system is placed in an inactive state. During Sample Measurement mode, the AES automatically performs liquid-liquid extractions in a process setting. The procedure for Single Measurement is the same, except only one measurement is performed. The following variables must be set in Administrative Mode prior to making measurements: process sample volume, pump delay time, solvent volume, acid volume, mixing cycle count, extraction delay time, and number of measurements to average.

The sample measurement procedure may be carried out as follows:
1. The piston pump draws in the process sample. The process sample volume is set in Administrative Mode.
2. The pump delays for a length of time set in Administrative Mode.
3. The piston pump draws in the solvent. The solvent volume is set in Administrative Mode.
4. The pump delays for a length of time set in Administrative Mode.
5. The piston pump draws in the acid. The volume is set in Administrative Mode.
6. The pump delays for a length of time set in Administrative Mode.
7. The Mixing Cycle is initiated. The mixing cycle count is set in Administrative Mode.
8. The extraction delay allows the extract to settle and allow bubbles to clear before measurements are taken. This length of time is set in Administrative Mode.
9. The fluorescence measurements are taken by the PX2. The number of measurements to average is set in Administrative Mode.
10. The piston pump expels all liquid from the mixing chamber.
11. The cleaning cycle is initiated.
12. The measurement cycle restarts from Step 1.

During the Cleaning mode, the AES draws in organic solvent to clean the system. The cleaning cycle procedure will generally involve the piston pump drawing in solvent. The solvent volume is set in Administrative Mode. The pump delays for a length of time set in Administrative Mode. The Mixing Cycle is initiated and repeats a plurality of times. Finally, the piston pump expels all liquid from the mixing chamber.

During the Backflush mode (which is a variation on the cleaning mode), solvent is pumped into the sample line entering the AES. The piston pump draws in solvent and again, the solvent volume is variable in Administrative Mode. The pump delays for a length of time set in Administrative Mode. Finally, the piston pump expels all liquid from the mixing chamber.

During the Auto-Tune mode, the user is prompted to enter a calibration sample into the system to perform an analyzer calibration. The AES will automatically determine the appropriate settings for the sample range, and store the calibration points. The AES should be Auto-Tuned on the highest concentration sample. The Auto-Tune procedure may operate as follows:
1. The user is prompted to insert the calibration sample, close the bypass outlet valve, and open the calibration sample valve.
2. The user is prompted to manually enter the concentration of the calibration sample (numeric values only).
3. The piston pump draws in the calibration sample. The calibration sample volume is variable in Administrative Mode.
4. The pump delays to allow sample to settle for a length of time set in Administrative Mode.
5. The AES performs Auto-Tune to determine the appropriate settings for the calibration sample.
6. The automated calibration procedure continues by prompting the user to add calibration samples in order of descending concentration.

The Tools (809) dropdown has the following options: Normal Mode, Administrative Mode, Log File Location, Display Run Status, Show Tools, and Enable Layout Changes. Normal Mode is the default mode that the AES system opens up to. In this mode, the user can view the live graphs and access the different measurement modes, however, the user cannot change any of the measurement variables. To view and edit measurement variables, the user must log into Administrative Mode (803).

Administrative Mode (803) is the password protected mode where the user may view and edit the measurement variables, access AES diagnostics, and manually enter calibration points. Entering Administrative Mode opens a new panel (805) on the left side of the frame with the following tabs: AES Settings (851), Sensor Settings (853), Sensor Measurements (855), and Diagnostics (857).

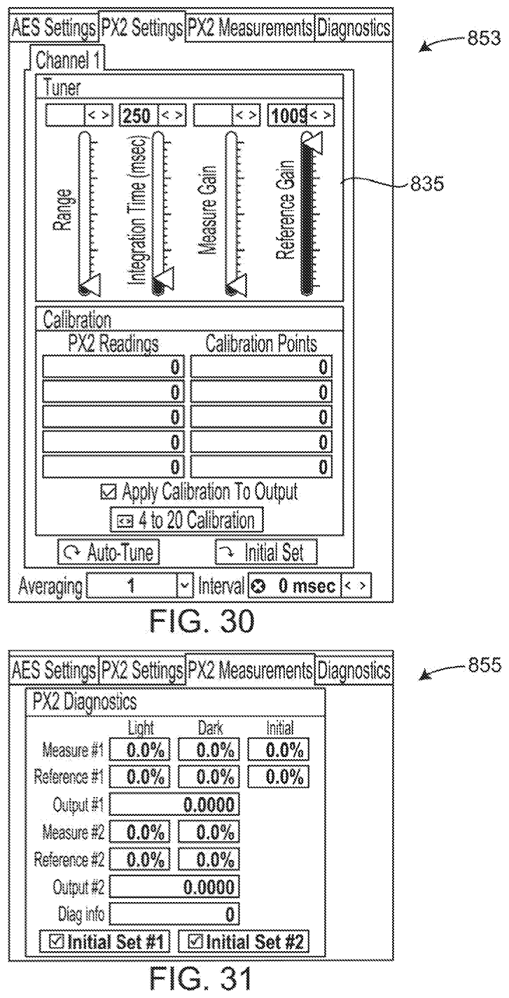

The AES Settings tab (851) as shown in FIG. 29 contains all of the volume and time variables that can be adjusted for a particular application. The Sensor Settings tab (853) is shown in FIG. 27 as it would appear in an auto-tune as contemplated above. FIG. 30 shows the Sensor Settings Tab (853) with the tuner (835) open. The tuner (835) can be manually adjusted to optimize the measurement settings. The tuner (835) gives the user full control of the settings that are automatically selected during Auto-Tune. Both the tuner (835) and calibration should generally not be adjusted manually unless the user is properly trained and instructed to do so. For fluorescence calibrations, the settings would preferably be optimized for the highest concentration sample. When adjusting the settings, the goal is to balance the Measure Light and Reference Light values between 85-95% of full scale, while keeping the Measure Dark and Reference Dark values as close to zero as possible.

| | | |
|---|---|---|
| TUNER | RANGE | (0-7) Adjusting will affect both the Measure and Reference |
| | | outputs; increase this value to decrease Measure and Reference |
| | | light output |
| | INTEGRATION TIME | (3-5,000 ms) Adjusting will affect both the Measure and |
| | | Reference outputs; increase this value to increase Measure and |
| | | Reference Light output |
| | MEASURE GAIN | (0-100%) Adjusting will affect ONLY the Measure outputs |
| | | (PMT-equipped units); increase this value to increase Measure |
| | | Light output |
| | REFERENCE GAIN | (0-100%) Adjusting will affect ONLY the Reference outputs; |
| | | increase this value to increase Reference Light output |
| | CALIBRATION | Manually adjust the PX2's calibration points |
| | AVERAGING | (1-16) Adjusting will change the number of measurements |
| | | averaged together to “smooth” readings |
| | INTERVAL | (250-60,000 ms) Adjusting will change the measurement interval |
| | | (time between each individual measurement). This does not |
| | | change the rate at which data is logged to file (see Section |
| | | 7 for Log File Setup information). |

The Sensor Measurements Tab (855) is provided in FIG. 31 and displays the raw light, dark, and output values for both channels (if applicable) contemplated above. Initial Set should only be selected when resetting the scale on a calibration sample. For absorbance units, the calibration sample must be the background sample, and for fluorescence units, this must be the highest concentration sample. Selecting initial set will effectively reset the calibration point corresponding with the highest Measure Light output.

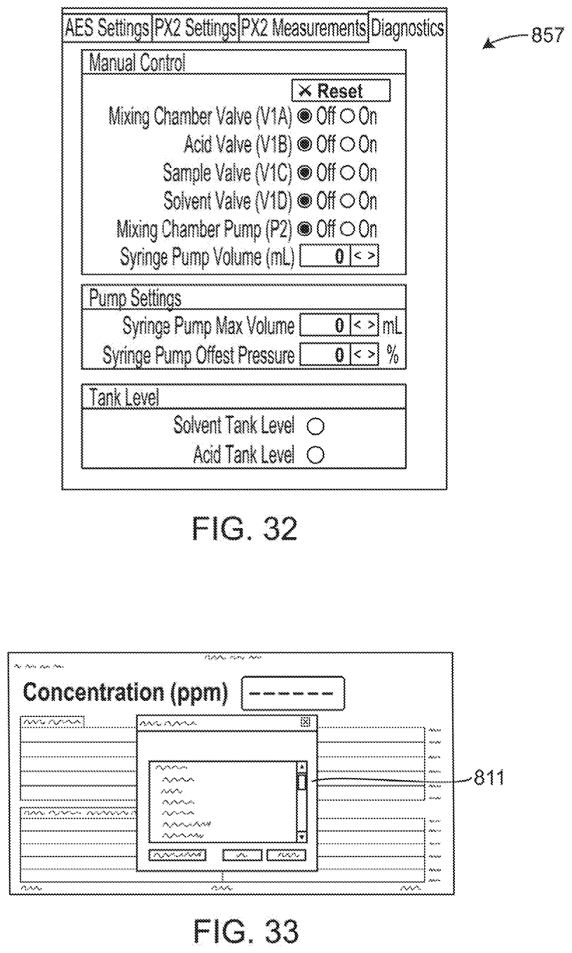

The Diagnostics Tab (857) is shown in FIG. 32 and gives the user the ability to manually actuate the various valves and pumps in the AES system. The user can also manually adjust the maximum pump stroke volume and syringe pump offset pressure. At the bottom of the panel, the user can see if either the solvent tank or acid tank levels are running low. These can be set up using the normally open contact that alarms the user when the tanks are low.

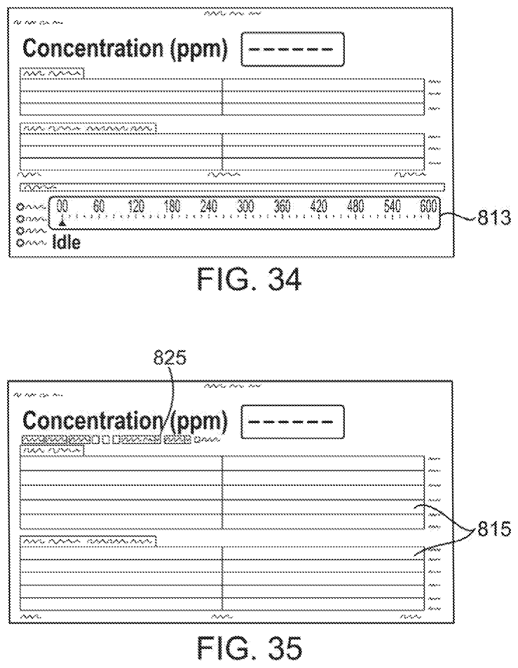

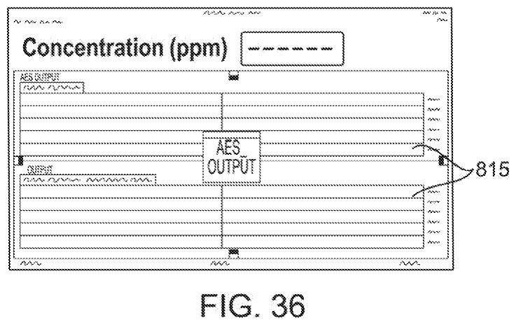

Returning from Administrative Mode (803) to the Normal Mode (801) screen, The Log File Location can be changed using the option as indicated in screen (811) in FIG. 33. The default location is set to the Desktop. Displaying the run status provides FIG. 34 and adds a panel (813) that shows measurement progress. This can be displayed and hidden by selecting Display Run Status in the Tools (809) drop down menu. Selecting the Show Tools option from the Tools (809) drop down menu will display the graphing tool bar (825) above the graphing panels (815) as shown in FIG. 35. The graphing tools will only affect what data is viewed in the graphic panels (815) and will not affect the analog or digital output, or the data saved to the log file. The user can start or stop the live display, clear the live display, change what data to view, and change how many data points the user sees in the graphing panel. Selecting Enable Layout Changes will allow the user to reorganize the graphing panels (815) by dragging and dropping them to new locations within the window as shown in FIG. 36.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “spherical” are purely geometric constructs and no real-world component or relationship is truly “spherical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A device for handling a sample comprising:
a pump;
a chamber spaced from said pump and having an attached probe; and
a valve arrangement;
wherein, said pump will provide a liquid sample from a sample source to said chamber, said liquid sample passing through said valve arrangement;
wherein, while said sample is moving through said valve arrangement, a liquid additive is simultaneously pulled from an additive source through said valve arrangement and said liquid sample and said liquid additive are mixed; and
wherein a measurement can be taken of said liquid sample and liquid additive mixture in said chamber.

2. The device of claim 1 wherein said liquid sample is an emulsion.

3. The device of claim 2 wherein said measurement is performed on said liquid sample while said sample is an emulsion.

4. The device of claim 2 wherein said liquid additive is a solvent separating a first immiscible from said emulsion.

5. The device of claim 4 wherein said measurement is performed on said first immiscible.

6. The device of claim 4 wherein said measurement is performed on what remains of said emulsion after said first immiscible has been separated.

7. The device of claim 2 wherein said emulsion is an oil and water emulsion.

8. The device of claim 7 wherein said additive is toluene.

9. The device of claim 1 wherein said measurement is a fluorescence measurement.

10. The device of claim 1 wherein said measurement is a light absorption measurement.
